(19) United States
(12) Patent Application Publication
(10) Pub. No.: US 2025/0309803 A1
(43) Pub. Date: Oct. 2, 2025

(54) CONTROL DEVICE FOR ROTATING MACHINE

(71) Applicant: Mitsubishi Electric Corporation, Tokyo (JP)

(72) Inventor: Tetsuya KOJIMA, Tokyo (JP)

(73) Assignee: Mitsubishi Electric Corporation, Tokyo (JP)

(21) Appl. No.: 18/862,962

(22) PCT Filed: Jun. 7, 2022
(86) PCT No.: PCT/JP2022/022926

§ 371 Date: Nov. 5, 2024

(51) Int. Cl. H02P 21/14; H02P 21/18; H02P 27/08

(52) U.S. Cl. CPC H02P 21/141; H02P 21/18; H02P 27/08

(57) ABSTRACT

A control device for a rotating machine includes a current detector that detects stator currents flowing through a stator of the rotating machine; a position estimator that computes a rotor position estimate and a rotational speed estimate on the basis of computed flux linkages of the rotating machine, the rotor position estimate being an estimated position of a rotor of the rotating machine, the rotational speed estimate being an estimated speed; a control unit that outputs stator voltage command values based on the stator currents and the rotor position estimate for driving the rotating machine; and a voltage application unit that applies drive voltages to the rotating machine on the basis of the stator voltage command values. The position estimator updates the computed flux linkages on the basis of the stator voltage command values, the rotational speed estimate, and the most recent computed flux linkages.

### FIELD

The present disclosure relates to a control device for a rotating machine with magnetic saliency, specifically a control device that controls a rotating machine whose inductance varies with a rotor position by obtaining rotor position information without using a position sensor that detects the rotor position.

### BACKGROUND

In order for a rotating machine to be driven with its performance fully brought out, rotor position information is necessary. To this end, a conventional control device for a rotating machine uses position information that is detected by a position sensor attached to the rotating machine. However, position sensor-less drive techniques have been developed for rotating machines from the perspectives of further reducing manufacturing costs of rotating machines, downsizing rotating machines, and improving reliability of rotating machines.

Position sensor-less control methods for rotating machines include a method of estimating a rotor position by applying high-frequency voltages to a rotating machine and a method of estimating the rotor position from, for example, induced voltages or flux linkages without applying high-frequency voltages. Patent Literature 1 mentioned below discloses a method of estimating the rotor position on the basis of flux linkages of a rotating machine. Specifically, the background section of Patent Literature 1 below discloses the technique of estimating the rotor position by performing control that makes armature current magnetic flux estimates, the flux linkages computed on the basis of a voltage equation for the rotating machine, converge to apparent armature current magnetic fluxes, the flux linkages computed using stator currents and inductances.

### CITATION LIST

### Patent Literature

Patent Literature 1: Japanese Patent Application Laid-open No. 2009-095135

### SUMMARY OF INVENTION

### Problem to be Solved by the Invention

According to the above-mentioned technique of Patent Literature 1, the flux linkages are computed by a flux observer on the basis of both stator voltages and the stator currents. For this reason, a problem with the technique described in Patent Literature 1 is complexity of position estimation control design. For example, when the computed flux linkages and the stator currents are used for the rotor position estimation, the stator currents are used not only in the rotor position estimation but also in the flux linkage computation, causing interference between the rotor position estimation and the flux linkage computation. Therefore, with the technique described in Patent Literature 1, highly responsive and highly accurate rotor position estimation is difficult.

The present disclosure has been made in view of the above, and an object of the present disclosure is to obtain a control device for a rotating machine that is capable of highly responsive and highly accurate rotor position estimation while preventing interference between flux linkage computation and position estimate computation.

### Means to Solve the Problem

In order to solve the above-stated problem and achieve the object, a control device for a rotating machine according to the present disclosure includes a current detector that detects stator currents flowing through a stator of the rotating machine and a position estimator that computes, on the basis of computed flux linkages of the rotating machine, a rotor position estimate that is an estimated position of a rotor of the rotating machine and a rotational speed estimate that is an estimated speed. The control device for the rotating machine also includes a control unit that outputs stator voltage command values based on the stator currents and the rotor position estimate for driving the rotating machine and a voltage application unit that applies drive voltages to the rotating machine on the basis of the stator voltage command values. The position estimator updates the computed flux linkages on the basis of stator voltage command values, the rotational speed estimate, and the most recent computed flux linkages.

### Effect of the Invention

The control device for the rotating machine according to the present disclosure has an effect of estimating the rotor position with high responsiveness and high accuracy while preventing interference between the flux linkage computation and the position estimate computation.

### BRIEF DESCRIPTION OF DRAWINGS

FIG. 1 is a diagram illustrating an exemplary configuration of a control device for a rotating machine according to a first embodiment.

FIG. 2 is a diagram illustrating a control method for converging a rotor position estimation error to zero in the first embodiment.

FIG. 3 is a diagram illustrating an exemplary configuration of a control device for a rotating machine according to a second embodiment.

FIG. 4 is a diagram illustrating a first exemplary hardware configuration of the control device for the rotating machine according to each of the first and second embodiments.

FIG. 5 is a diagram illustrating a second exemplary hardware configuration of the control device for the rotating machine according to each of the first and second embodiments.

### DESCRIPTION OF EMBODIMENTS

With reference to the accompanying drawings, a detailed description is hereinafter provided of control devices for rotating machines according to embodiments of the present disclosure.

### First Embodiment

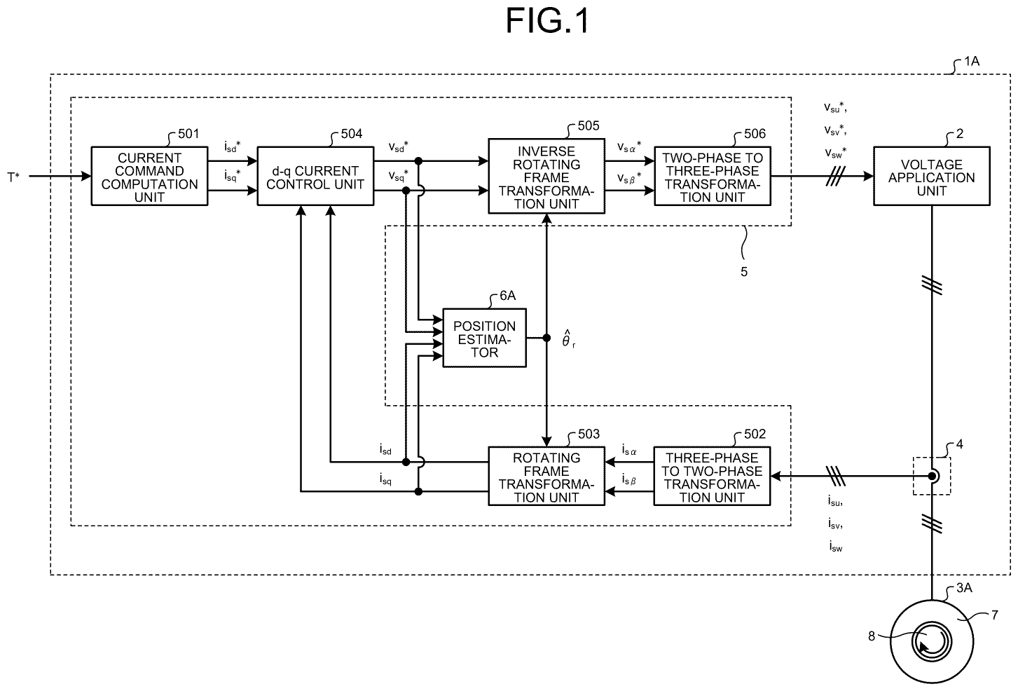

FIG. 1 is a diagram illustrating an exemplary configuration of a control device for a rotating machine according to a first embodiment. The control device 1A for the rotating machine according to the first embodiment is a control device that controls operation of the rotating machine 3A. As illustrated in FIG. 1, the control device 1A includes a voltage application unit 2, a current detector 4, a control unit 5, and a position estimator 6A. The current detector 4 is disposed between the voltage application unit 2 and the rotating machine 3A and detects stator currents iₛᵤ, iₛᵥ, and i_{sw} that flow through a stator 7 of the rotating machine 3A. The voltage application unit 2 applies drive voltages to the rotating machine 3A in accordance with stator voltage command values vₛᵤ*, vₛᵥ*, and v_{sw}* output from the control unit 5. Although not illustrated, a direct-current power supply, an inverter circuit, a pulse-width modulation (PWM) unit, and others are included in the voltage application unit 2. The inverter circuit converts a direct-current voltage output from the direct-current power supply into alternating-current voltages. The PWM unit generates PWM signals that drive switching elements of the inverter circuit.

The rotating machine 3A in the first embodiment is a rotating machine whose inductance includes a variable inductance component that varies with a rotor position and whose rotor 8 includes no magnets. An example of this type of rotating machine 3A is a synchronous reluctance motor. A direction of the rotor 8 in which the inductance is maximized is defined herein as a d-axis, and a direction of the rotor 8 in which the inductance is minimized is defined herein as a q-axis. For the rotor position, the d-axis of the rotor 8 is used as a reference. Both the inverter circuit and the rotating machine 3A are configured herein to be three-phase.

Using stator voltage command values v_{sd}* and v_{sq}* in a rotating frame and d- and q-axis currents i_{sd} and i_{sq} in the rotating frame, the position estimator 6A computes a rotor position estimate θ\hat{ }ᵣ that is an estimated position of the rotor 8. On the basis of the stator currents iₛᵤ, iₛᵥ, and i_{sw} and the rotor position estimate θ\hat{ }ᵣ, the control unit 5 generates and outputs the stator voltage command values vₛᵤ*, vₛᵥ*, and v_{sw}* for driving the rotating machine 3A. Specifically, the control unit 5 uses the stator currents iₛᵤ, iₛᵥ, and i_{sw} and the rotor position estimate θ\hat{ }ᵣ to generate the stator voltage command values vₛᵤ*, vₛᵥ*, and v_{sw}* in order for the rotating machine 3A to output a desired torque command value T*.

Next, a more detailed description of the operation of the control unit 5 is provided. As illustrated in FIG. 1, the control unit 5 includes a current command computation unit 501, a three-phase to two-phase transformation unit 502, a rotating frame transformation unit 503, a d-q current control unit 504, an inverse rotating frame transformation unit 505, and a two-phase to three-phase transformation unit 506.

The current command computation unit 501 computes current command values i_{sd}* and i_{sq}* in the rotating frame that are needed for the rotating machine 3A to generate an output corresponding to the torque command value T*. The current command values i_{sd}* and i_{sq}* in the two-phase rotating frame are selected herein to minimize a root-mean-square current value, that is to say, copper loss of the rotating machine 3A for the torque.

The three-phase to two-phase transformation unit 502 performs three-phase to two-phase transformation of the stator currents iₛᵤ, iₛᵥ, and i_{sw} in a three-phase frame into rotating machine currents i_{sα} and i_{sβ} in a two-phase stationary frame, as expressed by Formula (1) below.

$$Formula 1$$

$$[ \begin{matrix}{i}_{s α} \\ {i}_{s β}\end{matrix} ] = {\underbrace{\sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ]}}_{{C}_{32}} [ \begin{matrix}{i}_{su} \\ {i}_{sv} \\ {i}_{sw}\end{matrix} ] \qquad ( 1 )$$

In the first embodiment, a transformation matrix C₃₂ shown in Formula (1) above is used for the three-phase to two-phase transformation.

Using the rotor position estimate θ\hat{ }ᵣ, the rotating frame transformation unit 503 performs rotating frame transformation of the rotating machine currents i_{sα} and i_{sβ} in the two-phase stationary frame into the d- and q-axis currents i_{sd} and i_{sq} in the two-phase rotating frame, as expressed by Formula (2) below.

$$Formula 2$$

$$[ \begin{matrix}{i}_{sd} \\ {i}_{sq}\end{matrix} ] = {\underbrace{[ \begin{matrix}cos {\hat{θ}}_{r} & sin {\hat{θ}}_{r} \\ - sin {\hat{θ}}_{r} & cos {\hat{θ}}_{r}\end{matrix} ]}}_{{C}_{dq} ( {\hat{θ}}_{r} )} [ \begin{matrix}{i}_{s α} \\ {i}_{s β}\end{matrix} ] \qquad ( 2 )$$

In the first embodiment, a transformation matrix C_{dq}(θ\hat{ }ᵣ) shown in Formula (2) above is used for the rotating frame transformation.

The d-q current control unit 504 performs control that causes the d- and q-axis currents i_{sd} and i_{sq} from the rotating frame transformation unit 503, which has performed the rotating frame transformation, to match the current command values i_{sd}*and i_{sq}* and computes the stator voltage command values v_{sd}* and v_{sq}* in the two-phase rotating frame. For example, proportional-integral (PI) control is used for this current control.

Using the rotor position estimate θ\hat{ }ᵣ computed by the position estimator 6A, the inverse rotating frame transformation unit 505 performs inverse rotating frame transformation of the stator voltage command values v_{sd}* and v_{sq}* in the two-phase rotating frame into stator voltage command values v_{sα}* and v_{sβ}* in the two-phase frame, as expressed by Formula (3) below. In the first embodiment, a transformation matrix C_{dg}⁻¹ (θ\hat{ }ᵣ) shown in Formula (3) below is used for the inverse rotating frame transformation.

$$Formula 3$$

$$[ \begin{matrix}{v}_{s α}^{⋆} \\ {v}_{s β}^{⋆}\end{matrix} ] = {\underbrace{[ \begin{matrix}cos {\hat{θ}}_{r} & - sin {\hat{θ}}_{r} \\ sin {\hat{θ}}_{r} & cos {\hat{θ}}_{r}\end{matrix} ]}}_{{C}_{dq}^{1} ( {\hat{θ}}_{r} )} [ \begin{matrix}{v}_{sd}^{⋆} \\ {v}_{sq}^{⋆}\end{matrix} ] \qquad ( 3 )$$

The two-phase to three-phase transformation unit 506 transforms the stator voltage command values v_{sα}* and v_{sβ}* in the two-phase frame into the stator voltage command values vₛᵤ*, vₛᵥ*, and v_{sw}* in the three-phase frame, as expressed by Formula (4) below.

$$Formula 4$$

$$[ \begin{matrix}{v}_{su}^{⋆} \\ {v}_{sv}^{⋆} \\ {v}_{sw}^{⋆}\end{matrix} ] = {\underbrace{\sqrt{\frac{2}{3}} [ \begin{matrix}1 & 0 \\ - \frac{1}{2} & \frac{\sqrt{3}}{2} \\ - \frac{1}{2} & - \frac{\sqrt{3}}{2}\end{matrix} ]}}_{{C}_{32}} [ \begin{matrix}v \text{?} \\ {v}_{s β}^{⋆}\end{matrix} ] \qquad ( 4 )$$

$$\text{?} \text{indicates text missing or illegible when filed}$$

In the first embodiment, a transformation matrix C₂₃ shown in Formula (4) above is used for the two-phase to three-phase transformation.

Next, a description is provided of how the position estimator 6A estimates the rotor position, that is to say, computes the rotor position estimate θ\hat{ }ᵣ. To begin with, a model of the rotating machine 3A is expressed in the two-phase frame by Formulas (5) and (6) below.

$$Formula 5$$

$${v}_{s}^{αβ} = {R}_{s} {i}_{s}^{αβ} + \frac{d}{dt} {ψ}_{s}^{αβ} \qquad ( 5 )$$

$$Formula 6$$

$${ψ}_{s}^{αβ} = [ \begin{matrix}{L}_{savg} + {L}_{svar} cos ( 2 {θ}_{r} ) & {L}_{svar} sin ( 2 {θ}_{r} ) \\ {L}_{svar} sin ( 2 {θ}_{r} ) & {L}_{savg} + {L}_{svar} cos ( 2 {θ}_{r} )\end{matrix} ] {i}_{s}^{αβ} \qquad ( 6 )$$

In Formula (5) above, “vₛ^{αβ}” represents stator voltages, and “iₛ^{αβ}” represents the stator currents. The superscript “^{αβ}” indicates that the values are in the two-phase frame. In Formula (5) above, “Rₛ” represents winding resistance, and “Ψₛ^{αβ}” represents flux linkages of the rotating machine 3A that can be expressed using a matrix, as shown in Formula (6) above. As mentioned earlier, the inductance of the rotating machine 3A varies with the rotor position. Accordingly, the inductance of the rotating machine 3A is divided into two components: a mean component and a variable component. “L_{savg}” represents the mean inductance component that does not vary with the rotor position, while “Lₛᵥₐᵣ” represents the variable inductance component that varies at twice an electrical angular frequency at which the rotor position changes. The mean inductance component L_{savg} and the variable inductance component Lₛᵥₐᵣ are expressed respectively by Formulas (7) and (8) below, where d-axis inductance L_{sd} and q-axis inductance L_{sq} are used.

$$Formula 7$$

$${L}_{savg} = \frac{{L}_{sd} + {L}_{sq}}{2} \qquad ( 7 )$$

$$Formula 8$$

$${L}_{svar} = \frac{{L}_{sd} - {L}_{sq}}{2} \qquad ( 8 )$$

Rotating frame transformation of the flux linkages Ψₛ^{αβ} of above Formula (6) on the basis of the rotor position estimate θ\hat{ }ᵣ gives Formula (9) below.

$$Formula 9$$

$${ψ}_{s}^{dq} = {L}_{savg} {i}_{s}^{dq} + {L}_{svar} [ \begin{matrix}cos ( 2 ( {θ}_{r} - {\hat{θ}}_{r} ) ) & sin ( 2 ( {θ}_{r} - {\hat{θ}}_{r} ) ) \\ sin ( 2 ( {θ}_{r} - {\hat{θ}}_{r} ) ) & - cos ( 2 ( {θ}_{r} - {\hat{θ}}_{r} ) )\end{matrix} ] {i}_{s}^{dq} \qquad ( 9 )$$

The superscript “^{dq}” in Formula (9) above indicates that the values are in the two-phase rotating frame. In above Formula (9), the first term relates to the inductance's mean inductance component L_{savg}, which does not vary with the rotor position, and the second term relates to the inductance's variable inductance component Lₛᵥₐᵣ, which varies at twice the electrical angular frequency where the rotor position changes. Components generated by the variable inductance component Lₛᵥₐᵣ and the stator currents iₛ^{dq}, as described in the second term, are referred to as the “flux-linkage inductance variation components”. In the first embodiment, the flux-linkage inductance variation components are used in the rotor position estimation. Estimates of the flux-linkage inductance variation components are represented herein by “Ψ\hat{ }ₛᵥₐᵣ^{dq}”. The estimates Ψ\hat{ }ₛᵥₐᵣ^{dq} of the flux-linkage inductance variation components can be derived from the second term of above Formula (9) and expressed by Formula (10) below.

$$Formula 10$$

$${\hat{ψ}}_{svar}^{dq} = {L}_{svar} [ \begin{matrix}cos ( 2 ( {θ}_{r} - {\hat{θ}}_{r} ) ) & sin ( 2 ( {θ}_{r} - {\hat{θ}}_{r} ) ) \\ sin ( 2 ( {θ}_{r} - {\hat{θ}}_{r} ) ) & - cos ( 2 ( {θ}_{r} - {\hat{θ}}_{r} ) )\end{matrix} ] {i}_{s}^{dq} \qquad ( 10 )$$

As shown in Formula (10) above, the estimates Ψ\hat{ }ₛᵥₐᵣ₁^{dq} of the flux-linkage inductance variation components can be obtained by using the rotor position estimate θ\hat{ }ᵣ and the stator currents iₛ^{dq}. It is to be noted here that the rotating machine 3A in the first embodiment is the synchronous reluctance rotating machine with the rotor 8 that has no magnets, not allowing for the use of rotor flux in the rotor position estimation. Therefore, another method that does not use the rotor flux is required to accurately compute the estimates Ψ\hat{ }ₛᵥₐᵣ^{dq} of the flux-linkage inductance variation components.

Above Formula (10) is simplified here into Formula (11) below when the rotor position estimate θ\hat{ }ᵣ approximates a true rotor position θᵣ, that is, θ\hat{ }ᵣ≈θᵣ.

$$Formula 11$$

$${\hat{ψ}}_{svar}^{dq} = {L}_{svar} [ \begin{matrix}1 & 0 \\ 0 & - 1\end{matrix} ] {i}_{s}^{dq} \qquad ( 11 )$$

If there are computed values serving as references for the estimates Ψ\hat{ }ₛᵥₐᵣ^{dq} of the flux-linkage inductance variation components, the rotor position can be estimated by comparing the estimates Ψ\hat{ }ₛᵥₐᵣ^{dq} and the reference computed values. Accordingly, an approach described below is proposed.

Firstly, applying rotating frame transformation based on the rotor position estimate θ\hat{ }ᵣ to above Formula (5), which is a voltage equation, gives Formula (12) below.

$$Formula 12$$

$${v}_{s}^{dq} = {R}_{s} {i}_{s}^{dq} + \frac{d}{dt} {ψ}_{s}^{dq} + {\hat{ω}}_{r} J {ψ}_{s}^{dq} \qquad ( 12 )$$

In Formula (12) above, “ω\hat{ }ᵣ” represents an estimated rotational speed and is called herein the “rotational speed estimate”. The rotational speed estimate ω\hat{ }ᵣ is computed by the position estimator 6A, as described later. In Formula (12) above, “J” represents a transformation matrix expressed by Formula (13) below.

$$Formula 13$$

$$J = [ \begin{matrix}0 & - 1 \\ 1 & 0\end{matrix} ] \qquad ( 13 )$$

Rearranging above Formula (12) gives Formula (14) below.

$$Formula 14$$

$$\frac{d}{dt} {ψ}_{s}^{dq} = {v}_{s}^{dq} - {R}_{s} {i}_{s}^{dq} - {\hat{ω}}_{r} J {ψ}_{s}^{dq} \qquad ( 14 )$$

Theoretically, flux linkages Ψₛ^{dq} can be computed by integrating Formula (14) above; however, unknown initial values are a problem. Furthermore, since response of Formula (14) itself is oscillatory, an observer is commonly used for stable computation. From these perspectives, a flux observer that computes the flux linkages Ψₛ^{dq} can be configured on the basis of above Formula (14) to be Formula (15) below. Voltage drops due to the winding resistance RS in the second term of Formula (14) can be ignored when the rotational speed of the rotating machine 3A is above a certain level.

$$Formula 15$$

$$\frac{d}{dt} {ψ}_{s , calc}^{dq} = {v}_{s}^{dq} - {R}_{s} {i}_{s}^{dq} - {\hat{ω}}_{r} J {ψ}_{s , calc}^{dq} - H ( {ψ}_{s , calc}^{dq} - {ψ}_{s , obj}^{dq} ) \qquad ( 15 )$$

In Formula (15) above, “Ψ_{s,calc}^{dq}” represents computed values of the flux linkages Ψₛ^{dq}, and “H” represents feedback gain of the flux observer. “Ψ_{s,obj}^{dq}” represents target values to which the computed flux linkages Ψ_{s,calc}^{dq} should converge and are needed for the flux observer to achieve convergence. Formula (16) below, derived by setting differentials of the flux linkages Ψₛ^{dq}, that is, the left side of above Formula (14) representing a voltage equation to zero, can be used for computation of the target values Ψ_{s,obj}^{dq}.

$$Formula 16$$

$${ψ}_{s , obj}^{dq} = [ \begin{matrix}\frac{{v}_{sq} - {R}_{s} {i}_{sq}}{{\hat{ω}}_{r}} \\ - \frac{{v}_{sq} - {R}_{s} {i}_{sq}}{{\hat{ω}}_{r}}\end{matrix} ] \qquad ( 16 )$$

Since the target values Ψ_{s,obj}^{dq} are computed on the basis of the voltage equation, the target values Ψ_{s,obj}^{dq} are called herein the “voltage-based target values”. For the purpose of designing responsiveness of the flux observer, transforming above Formula (15) so that the computed flux linkages Ψ_{s,calc}^{dq} become variables gives Formula (17) below.

$$Formula 17$$

$$\frac{d}{dt} {ψ}_{s , calc}^{dq} = {v}_{s}^{dq} - \frac{{R}_{s}}{{L}_{savg} - {L}_{svar}} [ \text{} \begin{matrix}{L}_{savg} - {L}_{svar} cos ( 2 ( {θ}_{r} - {\hat{θ}}_{r} ) ) & - {L}_{svar} sin ( 2 ( {θ}_{r} - {\hat{θ}}_{r} ) ) \\ - {L}_{svar} sin ( 2 ( {θ}_{r} - {\hat{θ}}_{r} ) ) & {L}_{savg} + {L}_{svar} cos ( 2 ( {θ}_{r} - {\hat{θ}}_{r} ) )\end{matrix} ] {ψ}_{s , calc}^{dq} - {\hat{ω}}_{r} J {ψ}_{s , calc}^{dq} - H ( {ψ}_{s , calc}^{dq} - {ψ}_{s , obj}^{dq} ) \qquad ( 17 )$$

Since the true rotor position θᵣ is unknown here, the approximation, θᵣ≈θ\hat{ }ᵣ, gives Formula (18) below.

$$Formula 18$$

$$\frac{d}{dt} {ψ}_{s , calc}^{dq} = {v}_{s}^{dq} - [ \begin{matrix}\frac{{R}_{s}}{{L}_{sd}} & 0 \\ 0 & \frac{{R}_{s}}{{L}_{sd}}\end{matrix} ] {ψ}_{s , calc}^{dq} - {\hat{ω}}_{r} J {ψ}_{s , calc}^{dq} - H ( {ψ}_{s , calc}^{dq} - {ψ}_{s , obj}^{dq} ) \qquad ( 18 )$$

Using above Formula (18) and setting the feedback gain H of the flux observer, for example, to Formula (19) below allows the responsiveness of convergence to be designed as ω_{obs}.

$$Formula 19$$

$$H = [ \begin{matrix}- \frac{{R}_{s}}{{L}_{sd}} + {ω}_{obs} & - {\hat{ω}}_{r} \\ - {\hat{ω}}_{r} & - \frac{{R}_{s}}{{L}_{sd}} + {ω}_{obs}\end{matrix} ] \qquad ( 19 )$$

A summary of the above description is as follows. Firstly, the flux observer of the first embodiment is represented by Formulas (15), (16), and (19). In Formulas (15) and (16), the voltage drops Rₛiₛ^{dq} due to the winding resistance Rₛ can be ignored when the rotational speed is above the certain level. The stator voltage command values vₛ^{dq}* are used as stator voltages vₛ^{dq}. From the above perspectives, the flux observer is used in the first embodiment to compute the flux linkages Ψ_{s,calc}^{dq} on the basis of the stator voltage command values vₛ^{dq}*, the rotational speed estimate ω\hat{ }ᵣ, and the most recent computed flux linkages Ψ_{s,calc}^{dq}. The phrase “the most recent” refers to being temporally close and may refer to, for example, being closest to the current point in time. In other words, “the most recent computed flux linkages Ψ_{s,calc}^{dq}” mentioned here may be the latest values among past computed flux linkages Ψ_{s,calc}^{dq}. The same meaning is used in subsequent descriptions.

A more detailed computation method is explained as follows. The flux observer of the first embodiment computes the flux linkages Ψ_{s,calc}^{dq} on the basis of the stator voltage command values vₛ^{dq}*, the products of the rotational speed estimate ω\hat{ }ᵣ and the most recent computed flux linkages Ψ_{s,calc}^{dq}, and the quotients of the stator voltage command values vₛ^{dq}* by the rotational speed estimate ω\hat{ }ᵣ. “The products of the rotational speed estimate ω\hat{ }ᵣ and the most recent computed flux linkages Ψ_{s,calc}^{dq}” correspond to the third term in above Formula (15). “The quotients of the stator voltage command values vₛ^{dq}* by the rotational speed estimate ω\hat{ }ᵣ” correspond to above Formula (16).

An even more detailed computation method is explained as follows. The flux observer of the first embodiment computes the flux linkages Ψ_{s,calc}^{dq} on the basis of the stator voltage command values vₛ^{dq}*, the products of the rotational speed estimate ω\hat{ }ᵣ and the most recent computed flux linkages Ψ_{s,calc}^{dq}, and differences between the most recent computed flux linkages Ψ_{s,calc}^{dq} and the quotients of the stator voltage command values vₛ^{dq}* by the rotational speed estimate ω\hat{ }ᵣ. The “differences between the most recent computed flux linkages Ψ_{s,calc}^{dq} and the quotients of the stator voltage command values vₛ^{dq}* by the rotational speed estimate ω\hat{ }ᵣ” correspond to the fourth and fifth terms in above Formula (15).

A yet more detailed computation method is explained as follows. The flux observer of the first embodiment computes the flux linkages Ψ_{s,calc}^{dg} on the basis of first differences between the stator voltage command values vₛ^{dq}* and the products of the rotational speed estimate ω\hat{ }ᵣ and the most recent computed flux linkages Ψ_{s,calc}^{dq} and second differences between the most recent computed flux linkages Ψ_{s,calc}^{dq} and the quotients of the stator voltage command values vₛ^{dq}* by the rotational speed estimate ω\hat{ }ᵣ. The first differences correspond to the first and third terms of above Formula (15), and the above-mentioned second differences correspond to the fourth and fifth terms of above Formula (15). It is to be noted that the first differences are based on the differentials of the flux linkages Ψₛ, as shown in above Formula (14), while the second differences are based on steady-state values of the flux linkages Ψₛ, as shown in above Formula (15). In other words, the flux observer of the first embodiment computes the flux linkages Ψₛ on the basis of both the differentials and the steady-state values of the flux linkages Ψₛ. Unlike the flux observer of above-mentioned Patent Literature 1, the flux observer of the first embodiment does not use flux linkages computed using the stator currents and the inductances.

The computation methods for the flux linkages Ψ_{s,calc}^{dq} according to the first embodiment have been described above. However, the terms in above Formula (15), which forms the basis of the computation methods, can have their signs reversed depending on polarities of the stator voltages vₛ, the stator currents iₛ, and the flux linkages Ψₛ. Furthermore, various modifications of above Formula (16) are possible, depending on how the flux observer is configured. A vital point of the flux observer in the first embodiment is that components essential for computing the flux linkages Ψ_{s,calc}^{dq} are the stator voltage command values vₛ^{dq}*, the rotational speed estimate ω\hat{ }ᵣ, and the most recent computed flux linkages Ψ_{s,calc}^{dq}. In view of this perspective, the computed flux linkages Ψ_{s,calc}^{dq} are updated in the first embodiment by computing new flux linkages Ψ_{s,calc}^{dq} on the basis of the stator voltage command values vₛ^{dq}*, the rotational speed estimate ω\hat{ }ᵣ, and the most recent computed flux linkages Ψ_{s,calc}^{dq}.

Computed values of the flux-linkage inductance variation components are represented by “Ψ_{svar,calc}^{dq}”. The flux-linkage inductance variation components Ψ_{svar,calc}^{dq} can be computed using Formula (20) below, where the flux linkages Ψ_{s,calc}^{dq} computed by the flux observer are used.

$$Formula 20$$

$${ψ}_{svar , calc}^{dq} = {ψ}_{s , calc}^{dq} - {L}_{savg} {i}_{s}^{dq} \qquad ( 20 )$$

Above Formula (20) can be derived from the relations given by Formulas (9) and (10).

For the flux-linkage inductance variation components, using Formula (21) below, estimation errors can be computed from the computed flux-linkage inductance variation components Ψ_{svar,calc}^{dq} expressed by above Formula (20) and the flux-linkage inductance variation component estimates Ψ\hat{ }ₛᵥₐᵣ^{dq} expressed by above Formula (11).

$$Formula 21$$

$${\hat{ψ}}_{svar}^{dq} \times {ψ}_{svar , calc}^{dq} = \vert {\hat{ψ}}_{svar}^{dq} \vert \vert {ψ}_{svar , calc}^{dq} \vert sin ( 2 ( {θ}_{r} - {\hat{θ}}_{r} ) ) \qquad ( 21 )$$

Above Formula (21) can be expressed as Formula (22) below when the rotor position estimate θ\hat{ }ᵣ approximates the true rotor position θᵣ, that is, θ\hat{ }ᵣ≈θᵣ in above Formula (21).

$$Formula 22$$

$$- ( {\hat{θ}}_{r} - {θ}_{r} ) = \frac{1}{2} \frac{{\hat{ψ}}_{svar}^{dq} \times {ψ}_{svar , calc}^{dq}}{\vert {\hat{ψ}}_{svar}^{dq} \vert \vert {ψ}_{svar , calc}^{dq} \vert} \qquad ( 22 )$$

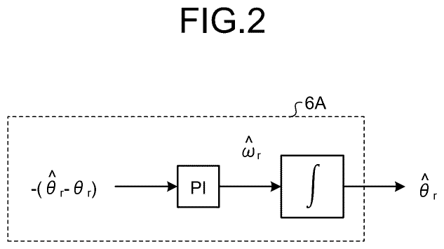

Above Formula (22) is a formula expressing a rotor position estimation error {−(θ\hat{ }ᵣ−θᵣ)}. FIG. 2 illustrates a control method for converging this estimation error {−(θ\hat{ }ᵣ−θᵣ)} to zero. FIG. 2 is a diagram illustrating the control method for converging the rotor position estimation error {−(θ\hat{ }ᵣ−θᵣ)} to zero in the first embodiment. In the first embodiment, the position estimator 6A follows the procedure shown in FIG. 2. Specifically, as illustrated in FIG. 2, the estimation error {−(θ\hat{ }ᵣ−θᵣ)} has only to undergo PI control and then be further integrated to converge to zero. In this procedure, an input to an integrator, that is to say, the output from the PI control is the rotational speed estimate ω\hat{ }ᵣ, and an output of the integrator is the rotor position estimate θ\hat{ }ᵣ.

Next, the approach of the first embodiment and the technique described in Patent Literature 1 are compared. In Patent Literature 1, as described earlier, values computed from the stator currents and the inductances are used as target values in the flux observer. These target values are called herein the “current-based target values” and are represented by “Ψ_{s,obj}^{dq′}”. As mentioned earlier, the approach of the first embodiment uses the voltage-based target values Ψ_{s,obj}^{dq}.

The current-based target values Ψ_{s,obj}^{dq′} used in Patent Literature 1 can be computed using Formula (23) below. Formula (23) below can be obtained by using the approximation, θ\hat{ }ᵣ≈θᵣ, in above Formula (9) and using the relations given by above Formulas (7) and (8).

$$\begin{matrix}Formula 23 & \\ {{ψ}_{s , obj}^{dq}}^{′} = [ \begin{matrix}{L}_{sd} & 0 \\ 0 & {L}_{sq}\end{matrix} ] {i}_{s}^{dq} & ( 23 )\end{matrix}$$

When the variable inductance component Lₛᵥₐᵣ is used for position estimation as in the first embodiment, the flux linkages Ψₛ in the rotating frame need to be computed on the basis of the rotor position estimate θ\hat{ }ᵣ, which includes the estimation error. For this computation, the voltage equation relating to the stator voltages vₛ^{dq} is used, as shown in above Formula (14). By comparing the computed values with the flux-linkage inductance variation component estimates Ψ\hat{ }ₛᵥₐᵣ^{dq}, which are the estimates computed using the rotor position estimate θ\hat{ }ᵣ and the stator currents iₛ^{dq} as in Formulas (10) and (11), the estimation error {−(θ\hat{ }ᵣ−θᵣ)} can be extracted.

Meanwhile, if the computed flux linkages Ψₛ are made to converge to the current-based target values Ψ_{s,obj}^{dq′}, which are computed from the stator currents iₛ^{dq}, as shown in above Formula (23), on the assumption that the rotor position estimate θ\hat{ }ᵣ is true, the estimation error {−(θ\hat{ }ᵣ−θᵣ)} cannot be extracted. More specifically, if the flux-linkage inductance variation components are computed using above Formula (20) through the use of the computed values from above Formula (23), the flux-linkage inductance variation components will become equal to the estimates from above Formula (11). This means that the error in the rotor position estimate θ\hat{ }ᵣ, as expressed in the second term of above Formula (9), and variations in the flux linkages Ψₛ due to the variable inductance component Lₛᵥₐᵣ are ignored. However, if the flux observer is designed to have a slow response speed for causing the convergence to the current-based target values Ψ_{s,obj}^{dq}′, the flux linkages Ψₛ computed on the basis of the voltage equation will slowly follow the current-based target values Ψ_{s,obj}^{dq′}, mitigating the effects. Meanwhile, designing for the slow response speed causes the flux linkages Ψₛ, which are computed on the basis of the voltage equation represented by above Formula (14), to be oscillatory. Therefore, the response speed of the flux observer needs to be at least a certain value. This is how the control design using the flux observer interferes with the position estimation control design, resulting in a problem with the technique described in Patent Literature 1 and making stable and highly responsive rotor position estimation difficult.

By contrast, the approach of the first embodiment includes computing the flux linkages Ψₛ on the basis of the voltage equation using the stator voltages vₛ and making the computed flux linkages Ψₛ converge to the voltage-based target values Ψ_{s,obj}^{dq} given by Formula (16). Therefore, the approach of the first embodiment allows for highly responsive and highly accurate rotor position estimation through the computation of the flux-linkage inductance variation components, with the computation of the position estimate not interfering with the computation of the flux linkages Ψₛ.

Besides Patent Literature 1, Japanese Patent Application Laid-open No. 2006-288083 (hereinafter referred to as “Patent Literature 2”), for example, shows another conventional technique. The technique described in Patent Literature 2 uses what are called herein the voltage-based target values Ψ_{s,obj}^{dq} directly for position estimate computation without using a flux observer. A problem with this technique is that using only the steady-state values of the flux linkages Ψₛ results in time-consuming convergence of the computed flux linkages Ψₛ and also leads to a slow response in position estimation.

By contrast, the approach of the first embodiment uses not only the steady-state values of the flux linkages Ψₛ but also the differentials of the flux linkages Ψₛ for the computation of the flux linkages Ψₛ. Therefore, the approach of the first embodiment allows for the rotor position estimation through the highly responsive computation of the flux linkages Ψₛ.

Yet another conventional technique is shown, for example, in Japanese Patent Application Laid-open No. 2018-183005 (hereinafter referred to as “Patent Literature 3”). The technique described in Patent Literature 3 involves computing the flux linkages Ψₛ on the basis of the voltage equation in the two-phase frame, which is the stationary frame. Rearranging above Formula (5) gives following Formula (24) for the differentials of the flux linkages Ψₛ.

$$\begin{matrix}Formula 24 & \\ \frac{d}{dt} {ψ}_{s}^{αβ} = {v}_{s}^{αβ} - {R}_{s} {i}_{s}^{αβ} & ( 24 )\end{matrix}$$

Since the parameters of the rotating machine 3A in the stationary frame are alternating current, their steady-state values are zero. Furthermore, if initial values of the flux linkages Ψₛ are set to zero, the flux linkages Ψₛ can be computed by integration. In that case, the technique described in Patent Literature 3 applies a high-pass filter, such as the one shown in Formula (25) below, to remove a direct-current component and low-frequency components.

$$\begin{matrix}Formula 25 & \\ \frac{d}{dt} {ψ}_{s}^{αβ} = {v}_{s}^{αβ} - {R}_{s} {i}_{s}^{αβ} - {ω}_{hpf} {ψ}_{s}^{αβ} & ( 25 )\end{matrix}$$

In Formula (25) above, “ω_{hpf}” represents a cutoff angular frequency of the high-pass filter. The use of the high-pass filter in Patent Literature 3 solves the problem of the initial values. Furthermore, using the high-pass filter restrains drift of the integral that is caused by disturbances and others. However, since the parameters of the rotating machine 3A are alternating current, high rotational speeds and high frequencies of the parameters of the rotating machine 3A result in fewer sampling points for the control computation. As a result, oscillations occur in the integration of the flux linkages Ψₛ, problematically causing the rotor position estimation, which uses the integration, to become unstable. Another problem with the technique described in Patent Literature 3 is that using the high-pass filter to remove the low-frequency components, which should ideally be included in the computed values, results in a reduced response speed and reduced accuracy, particularly during a transient response.

By contrast, the approach of the first embodiment allows for the computation of the flux linkages Ψₛ in the rotating frame by using the flux observer and the voltage-based target values Ψ_{s,obj}^{dq}. Since the parameters of the rotating machine 3A in the rotating frame are direct current, the problem of sampling points is mitigated even at high rotational speeds. Furthermore, using the flux observer enables the flux linkages Ψₛ to converge to the voltage-based target values Ψ_{s,obj}^{dq}, eliminating the need to remove low-frequency components. Therefore, the approach of the first embodiment allows for the rotor position estimation through the highly accurate, highly responsive, and highly stable computation of the flux linkages Ψₛ.

As described above, the control device for the rotating machine according to the first embodiment includes the current detector that detects the stator currents flowing through the stator of the rotating machine and the position estimator that computes the rotor position estimate and the rotational speed estimate on the basis of the computed flux linkages of the rotating machine. The position estimator updates the computed flux linkages on the basis of the stator voltage command values, the rotational speed estimate, and the most recent computed flux linkages. This enables the rotor position to be estimated with high responsiveness and high accuracy.

The approach of the first embodiment can use the flux-linkage inductance variation components when the flux linkages are computed. The flux-linkage inductance variation components are the flux components generated by the variable inductance component and the stator currents. When the inductance of the rotating machine is divided into the mean component, which does not vary with the rotor position, and the variable component, which varies at twice the electrical angular frequency where the rotor position changes, the variable inductance component refers to the latter component. Using this variable inductance component in the rotor position estimation allows for highly responsive and highly accurate rotor position estimation, a remarkable effect not conventionally seen.

### Second Embodiment

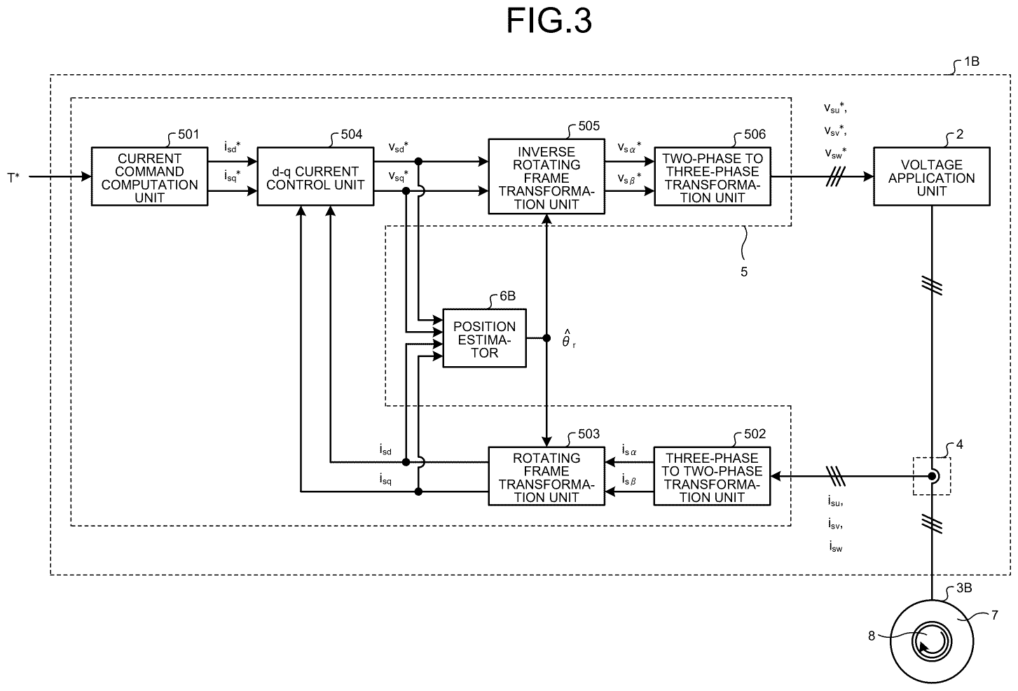

FIG. 3 is a diagram illustrating an exemplary configuration of a control device for a rotating machine according to a second embodiment. Compared with the first embodiment's configuration illustrated in FIG. 1, the configuration of the second embodiment has the control device 1B replacing the control device 1A and the rotating machine 3B replacing the rotating machine 3A. Furthermore, the control device 1B has a position estimator 6B replacing the position estimator 6A. The configuration is otherwise identical or equivalent to that of FIG. 1, and identical or equivalent constituent elements have the same reference characters. In the second embodiment, descriptions of details identical or equivalent to those in the first embodiment are omitted as appropriate.

The rotating machine 3B in the second embodiment is a rotating machine whose inductance includes a variable inductance component that varies with a rotor position and whose rotor 8 includes magnets. An example of this type of rotating machine 3B is an interior permanent magnet motor with magnets embedded in the rotor 8. In the second embodiment, an N-pole direction of the magnets of the rotor 8 is defined as a d-axis. For the rotor position, the d-axis of the rotor 8 is used as a reference. A q-axis is in a direction that is electrically 90° ahead of the d-axis in a direction of rotation. As in the first embodiment, both the inverter circuit and the rotating machine 3B are configured to be three-phase.

Next, a description is provided of how the position estimator 6B estimates the rotor position, that is to say, computes the rotor position estimate θ\hat{ }ᵣ. To begin with, a model of the rotating machine 3B is expressed in a two-phase frame by Formulas (26) and (27) below.

$$\begin{matrix}Formula 26 & \\ {v}_{s}^{αβ} = {R}_{s} {i}_{s}^{αβ} + \frac{d}{dt} {ψ}_{s}^{αβ} & ( 26 )\end{matrix}$$

$$\begin{matrix}Formula 27 & \\ {ψ}_{s}^{αβ} = [ \begin{matrix}{L}_{savg} + {L}_{svar} cos ( 2 {θ}_{r} ) & {L}_{svar} sin ( 2 {θ}_{r} ) \\ {L}_{svar} sin ( 2 {θ}_{r} ) & {L}_{savg} - {L}_{svar} cos ( 2 {θ}_{r} )\end{matrix} ] {i}_{s}^{αβ} + [ \begin{matrix}cos {θ}_{r} \\ sin {θ}_{r}\end{matrix} ] {ψ}_{m} & ( 27 )\end{matrix}$$

In Formula (27) above, “Ψₘ” represents flux linkage created by the permanent magnets and is called herein “magnet flux”. Rotating frame transformation of the flux linkages Ψₛ^{αβ} of above Formula (27) on the basis of the rotor position estimate θ\hat{ }ᵣ gives Formula (28) below.

$$\begin{matrix}Formula 28 & \\ {ψ}_{s}^{dq} = {L}_{savg} {i}_{s}^{dq} + {L}_{svar} [ \begin{matrix}cos ( 2 ( {θ}_{r} - {\hat{θ}}_{r} ) ) & sin ( 2 ( {θ}_{r} - {\hat{θ}}_{r} ) ) \\ sin ( 2 ( {θ}_{r} - {\hat{θ}}_{r} ) ) & - cos ( 2 ( {θ}_{r} - {\hat{θ}}_{r} ) )\end{matrix} ] {i}_{s}^{dq} + {\underbrace{[ \begin{matrix}cos ( {θ}_{r} - {\hat{θ}}_{r} ) \\ sin ( {θ}_{r} - {\hat{θ}}_{r} )\end{matrix} ] {ψ}_{m}}}_{{ψ}_{m}^{dq}} & ( 28 )\end{matrix}$$

“Ψₘ^{dq}” in the third term of above Formula (28) represents components of the magnet flux Ψₘ in a two-phase rotating frame. In Formula (28) above, the first term relates to the inductance's mean inductance component L_{savg}, which does not vary with the rotor position, and the second term relates to the inductance's variable inductance component Lₛᵥₐᵣ, which varies at twice the electrical angular frequency where the rotor position changes. In the second embodiment, the q-axis component of the magnet flux Ψₘ described in the third term is used for the rotor position estimation.

Given safety, the environment, and costs, rotating machines with small magnet flux and high reluctance torque (i.e., a large variable inductance component) have started to prevail in recent products, such as those for automobiles. Therefore, flux linkages based on the variable inductance component Lₛᵥₐᵣ, as described in the second term, need to be accurately computed for accurate computation of the magnet flux in the third term.

Next, a description is provided of how the flux linkages are computed in the second embodiment. Firstly, applying rotating frame transformation based on the rotor position estimate θ\hat{ }ᵣ to above Formula (26), which is a voltage equation, followed by rearrangement, gives Formula (29) below.

$$\begin{matrix}Formula 29 & \\ \frac{d}{dt} {ψ}_{s}^{dq} = {v}_{s}^{dq} - {R}_{s} {i}_{s}^{dq} - {\hat{ω}}_{r} J {ψ}_{s}^{dq} & ( 29 )\end{matrix}$$

Theoretically, the flux linkages Ψ_{sd}^{q} can be computed by integrating Formula (29) above; however, unknown initial values are a problem. Furthermore, since response of Formula (29) itself is oscillatory, an observer is commonly used for stable computation. From these perspectives, a flux observer that computes the flux linkages Ψₛ^{dq} can be configured on the basis of above Formula (29) to be Formula (30) below. Voltage drops due to the winding resistance Rₛ in the second term of Formula (29) can be ignored when rotational speed of the rotating machine 3B is above a certain level.

$$\begin{matrix}Formula 30 & \\ \frac{d}{dt} {ψ}_{s , calc}^{dq} = {v}_{s}^{dq} - {R}_{s} {i}_{s}^{dq} - {\hat{ω}}_{r} J {ψ}_{s , calc}^{dq} - H ( {ψ}_{s , calc}^{dq} - {ψ}_{s , obj}^{dq} ) & ( 30 )\end{matrix}$$

Formula (31) below, derived by setting differentials of the flux linkages Ψₛ^{dq}, that is, the left side of above Formula (29) representing a voltage equation to zero, can be used here for computation of the target values Ψ_{s,obj}^{dq}.

$$\begin{matrix}Formula 31 & \\ {ψ}_{s , obj}^{dq} = [ \begin{matrix}\frac{{v}_{sq} - {R}_{s} {i}_{sq}}{{\hat{ω}}_{r}} \\ - \frac{{v}_{sd} - {R}_{s} {i}_{sd}}{{\hat{ω}}_{r}}\end{matrix} ] & ( 31 )\end{matrix}$$

Since the target values Ψ_{s,obj}^{dq} are computed on the basis of the voltage equation, the target values Ψ_{s,obj}^{dq} are called the “voltage-based target values” in the second embodiment as well. For the purpose of designing responsiveness of the flux observer, transforming above Formula (30) so that the computed flux linkages Ψ_{s,calc}^{dq} become variables gives Formula (32) below.

$$\begin{matrix}Formula 32 & \\ \frac{d}{dt} \text{?} = \text{?} - \frac{\text{?}}{\text{?} - \text{?}} [ \begin{matrix}\text{?} - \text{?} cos ( 2 ( {θ}_{r} - \text{?} ) ) & - \text{?} sin ( 2 ( \text{?} - \text{?} ) ) \\ - \text{?} sin ( 2 ( {θ}_{r} - \text{?} ) ) & \text{?} + \text{?} cos ( 2 ( {θ}_{r} - \text{?} ) )\end{matrix} ] ( {ψ}_{s , calc}^{dq} - \text{?} ) - \text{?} J {ψ}_{s , calc}^{dq} - H ( {ψ}_{s , calc}^{dq} - {ψ}_{s , obj}^{dq} ) & ( 32 )\end{matrix}$$

$$\text{?} \text{indicates text missing or illegible when filed}$$

Since the true rotor position θᵣ is unknown here, the approximation, θᵣ≈θ\hat{ }ᵣ, gives Formula (33) below.

$$\begin{matrix}Formula 33 & \\ \frac{d}{dt} {ψ}_{s , calc}^{dq} = {v}_{s}^{dq} - [ \begin{matrix}\frac{{R}_{s}}{{L}_{sd}} & 0 \\ 0 & \frac{{R}_{s}}{{L}_{sq}}\end{matrix} ] {ψ}_{s , calc}^{dq} + [ \begin{matrix}\frac{{R}_{s}}{{L}_{sd}} & 0 \\ 0 & \frac{{R}_{s}}{{L}_{sq}}\end{matrix} ] [ \begin{matrix}1 \\ 0\end{matrix} ] {ψ}_{m} - {\hat{ω}}_{r} J {ψ}_{s , calc}^{dq} - H ( {ψ}_{s , calc}^{dq} - {ψ}_{s , obj}^{dq} ) & ( 33 )\end{matrix}$$

Using above Formula (33) and setting the feedback gain H of the flux observer, for example, to Formula (34) below allows the responsiveness of convergence to be designed as ω_{obs}.

$$\begin{matrix}Formula 34 & \\ H = [ \begin{matrix}- \frac{{R}_{s}}{{L}_{sd}} + {ω}_{obs} & {\hat{ω}}_{r} \\ - {\hat{ω}}_{r} & - \frac{{R}_{s}}{{L}_{sq}} + {ω}_{obs}\end{matrix} ] & ( 34 )\end{matrix}$$

A summary of the above description is as follows. Firstly, the flux observer of the second embodiment is represented by Formulas (30), (31), and (34). In Formulas (30) and (31), the voltage drops Rₛiₛ^{dq} due to the winding resistance Rₛ can be ignored when the rotational speed is above the certain level. The stator voltage command values vₛ^{dq}* are used as the stator voltages vₛ^{dq}. From the above perspectives, the flux observer is used in the second embodiment to compute the flux linkages Ψ_{s,calc}^{dq} on the basis of the stator voltage command values vₛ^{dq}*, the rotational speed estimate ω\hat{ }ᵣ, and the most recent computed flux linkages Ψ_{s,calc}^{dq}.

A more detailed computation method is explained as follows. The flux observer of the second embodiment computes the flux linkages Ψ_{s,calc}^{dq} on the basis of the stator voltage command values vₛ^{dq}*, the products of the rotational speed estimate ω\hat{ }ᵣ and the most recent computed flux linkages Ψ_{s,calc}^{dq}, and the quotients of the stator voltage command values vₛ^{dq}* by the rotational speed estimate ω\hat{ }ᵣ. “The products of the rotational speed estimate ω\hat{ }ᵣ and the most recent computed flux linkages Ψ_{s,calc}^{dq}” correspond to the third term in above Formula (30). “The quotients of the stator voltage command values vₛ^{dq}* by the rotational speed estimate ω\hat{ }ᵣ” correspond to above Formula (31).

An even more detailed computation method is explained as follows. The flux observer of the second embodiment computes the flux linkages Ψ_{s,calc}^{dq} on the basis of the stator voltage command values vₛ^{dq}*, the products of the rotational speed estimate ω\hat{ }ᵣ and the most recent computed flux linkages Ψ_{s,calc}^{dq}, and differences between the most recent computed flux linkages Ψ_{s,calc}^{dq} and the quotients of the stator voltage command values vₛ^{dq}* by the rotational speed estimate ω\hat{ }ᵣ. The “differences between the most recent computed flux linkages Ψ_{s,calc}^{dq} and the quotients of the stator voltage command values vₛ^{dq}* by the rotational speed estimate ω\hat{ }ᵣ” correspond to the fourth and fifth terms in above Formula (30).

A yet more detailed computation method is explained as follows. The flux observer of the second embodiment computes the flux linkages Ψ_{s,calc}^{dq} on the basis of first differences between the stator voltage command values vₛ^{dq}* and the products of the rotational speed estimate ω\hat{ }ᵣ and the most recent computed flux linkages Ψ_{s,calc}^{dq} and second differences between the most recent computed flux linkages Ψ_{s,calc}^{dq} and the quotients of the stator voltage command values vₛ^{dq}* by the rotational speed estimate ω\hat{ }ᵣ. The first differences correspond to the first and third terms of above Formula (30), and the second differences correspond to the fourth and fifth terms of above Formula (30). It is to be noted that the first differences are based on the differentials of the flux linkages Ψₛ, as shown in above Formula (29), while the second differences are based on steady-state values of the flux linkages Ψₛ, as shown in above Formula (30). In other words, the flux observer of the second embodiment computes the flux linkages Ψₛ on the basis of both the differentials and the steady-state values of the flux linkages Ψₛ. Unlike the flux observer of above-mentioned Patent Literature 1, the flux observer of the second embodiment does not use the flux linkages computed using the stator currents and the inductances.

The computation methods for the flux linkages Ψ_{s,calc}^{dq} according to the second embodiment have been described above. However, the terms in above Formula (30), which forms the basis of the computation methods, can have their signs reversed depending on the polarities of the stator voltages vₛ, the stator currents is, and the flux linkages Ψₛ. Furthermore, various modifications of above Formula (16) are possible, depending on how the flux observer is configured. A vital point of the flux observer in the first embodiment is that components essential for computing the flux linkages Ψ_{s,calc}^{dq} are the stator voltage command values vₛ^{dq}*, the rotational speed estimate ω\hat{ }ᵣ, and the most recent computed flux linkages Ψ_{s,calc}^{dq}. In view of this perspective, the computed flux linkages Ψ_{s,calc}^{dq} are updated in the second embodiment by computing new flux linkages Ψ_{s,calc}^{dq} on the basis of the stator voltage command values vₛ^{dq}*, the rotational speed estimate ω\hat{ }ᵣ, and the most recent computed flux linkages Ψ_{s,calc}^{dq}.

A computed value of the q-axis component of the magnet flux Ψₘ^{dq} described in the third term of Formula (28) above is represented by “Ψ_{mq,calc}”. This value Ψ_{mq,calc} can be computed using Formula (35) below, where the flux linkage Ψ_{sq,calc} computed by the flux observer is used.

$$\begin{matrix}Formula 35 & \\ {ψ}_{mq , calc} = {ψ}_{sq , calc} - {L}_{sq} {i}_{sq} & ( 35 )\end{matrix}$$

Above Formula (35) can be derived from the approximation, θ\hat{ }ᵣ≈θᵣ, in above Formula (28) and the relations given by Formulas (9) and (10).

The q-axis component in the third term of above Formula (28) corresponds to the computed q-axis component Ψ_{mq,calc} on the left side of Formula (35) above and thus can be expressed by Formula (36) below.

$$\begin{matrix}Formula 36 & \\ {ψ}_{m} sin ( {θ}_{r} - {\hat{θ}}_{r} ) = {ψ}_{mq , calc} & ( 36 )\end{matrix}$$

Using the relation, θ\hat{ }ᵣ≈θᵣ, in above Formula (36) allows above Formula (36) to be expressed as Formula (37) below.

$$\begin{matrix}Formula 37 & \\ - ( {\hat{θ}}_{r} - {θ}_{r} ) = \frac{{ψ}_{mq , calc}}{{ψ}_{m}} & ( 37 )\end{matrix}$$

Above Formula (37) is a formula expressing the rotor position estimation error {−(θ\hat{ }ᵣ−θᵣ)}. As in the first embodiment, the estimation error {−(θ\hat{ }r−θᵣ)} undergoes PI control and is then integrated to converge to zero. This allows for the estimation of the rotor position. In this case as well, an input to an integrator is the rotational speed estimate ω\hat{ }ᵣ, and an output of the integrator is the rotor position estimate θ\hat{ }ᵣ.

Next, the approach of the second embodiment and the technique described in Patent Literature 1 are compared. When the technique described in Patent Literature 1 is applied to the second embodiment, the current-based target values Ψ_{s,obj}^{dq′} used in Patent Literature 1 can be expressed by Formula (38) below.

$$\begin{matrix}Formula 38 & \\ {{ψ}_{s , obj}^{dq}}^{′} = [ \begin{matrix}{L}_{sd} & 0 \\ 0 & {L}_{sq}\end{matrix} ] {i}_{s}^{dq} + [ \begin{matrix}1 \\ 0\end{matrix} ] {ψ}_{m} & ( 38 )\end{matrix}$$

However, if the computed flux linkages Ψₛ are made to converge to the current-based target values Ψ_{s,obj}^{dq′}, which are computed from the stator currents iₛ^{dq}, as shown in above Formula (38), on the assumption that the rotor position estimate θ\hat{ }ᵣ is true, the q-axis component of the magnet flux Ψₘ, shown in the third term of above Formula (28) and which is used for the position estimation, cannot be extracted. Furthermore, the error in the rotor position estimate θ\hat{ }ᵣ, as shown in the second term of above Formula (28), and variations in the flux linkages Ψₛ due to the variable inductance component Lₛᵥₐᵣ are ignored. The effects are particularly significant for rotating machines with small magnet flux Ψₘ and a large variable inductance component Lₛᵥₐᵣ. Even using the measure to adjust the response of the flux observer, as described in the first embodiment, results in complexity where the control design using the flux observer interferes with the position estimation control design, making stable and highly responsive rotor position estimation difficult.

By contrast, the approach of the second embodiment includes computing the flux linkages Ψₛ on the basis of the voltage equation using the stator voltages vₛ and making the computed flux linkages Ψₛ converge to the voltage-based target values Ψ_{s,obj}^{dq} given by Formula (31). Therefore, the approach of the second embodiment allows for highly responsive and highly accurate rotor position estimation through the computation of the flux-linkage inductance variation components, with the computation of the position estimate not interfering with the computation of the flux linkages Ψₛ.

As described in the first embodiment, the technique described in Patent Literature 2 uses what are called herein the voltage-based target values Ψ_{s,obj}^{dq} directly for position estimate computation without using a flux observer. A problem with this technique is that using only the steady-state values of the flux linkages Ψₛ results in time-consuming convergence of the computed flux linkages Ψₛ and also leads to a slow response in position estimation.

By contrast, the approach of the second embodiment uses not only the steady-state values of the flux linkages Ψₛ but also the differentials of the flux linkages Ψₛ for the computation of the flux linkages Ψₛ. Therefore, the approach of the second embodiment allows for the rotor position estimation through the highly responsive computation of the flux linkages Ψₛ.

As described above, even when the rotating machine has the permanent magnets, the position estimator included in the control device for the rotating machine according to the second embodiment updates the computed flux linkages on the basis of the stator voltage command values, the rotational speed estimate, and the most recent computed flux linkages. This enables the rotor position to be estimated with high responsiveness and high accuracy even when the magnet flux of the rotating machine is used for rotor position estimation.

The functions of each of the control devices 1A and 1B for the rotating machines, as described in the first and second embodiments, can be implemented with processing circuitry. The functions of the control device 1A or 1B refer to the functions of the control unit 5 and the position estimator 6A or 6B.

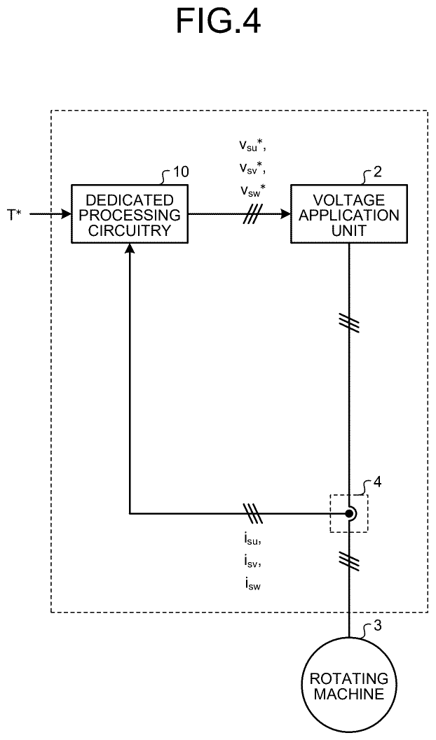

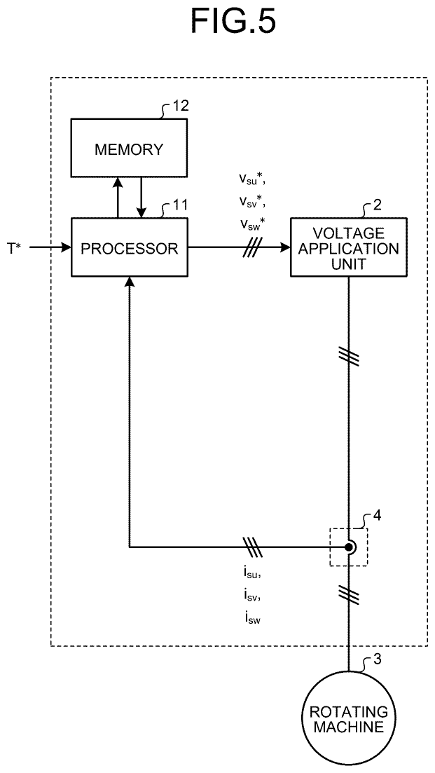

FIG. 4 is a diagram illustrating a first exemplary hardware configuration of the control device for the rotating machine according to each of the first and second embodiments. FIG. 5 is a diagram illustrating a second exemplary hardware configuration of the control device for the rotating machine according to each of the first and second embodiments. A rotating machine 3 illustrated in FIGS. 4 and 5 refers to either the rotating machine 3A described in the first embodiment or the rotating machine 3B described in the second embodiment. The processing circuitry may be dedicated hardware, such as dedicated processing circuitry 10 illustrated in FIG. 4, or may include, as illustrated in FIG. 5, a processor 11 and a memory 12 storing programs that operate the processor 11.

The dedicated processing circuitry 10, which is used as the dedicated hardware, corresponds to a single circuit, a composite circuit, a programmed processor, a parallel programmed processor, an application-specific integrated circuit (ASIC), a field-programmable gate array (FPGA), or a combination of these. The functions of each of the control devices 1A and 1B may be implemented individually or collectively with the processing circuitry.

When the processor 11 and the memory 12 are used, the functions of each of the control devices 1A and 1B are implemented with software, firmware, or a combination of these. The software or the firmware is described as programs and is stored in the memory 12. The processor 11 reads and executes the programs stored in the memory 12. These programs can be said to cause a computer to execute the steps and the method that the processor 11 performs. The memory 12 corresponds to a semiconductor memory, such as a random-access memory (RAN), a read-only memory (ROM), a flash memory, an erasable programmable read-only memory (EPROM), or an electrically erasable programmable read-only memory (EEPROM) (registered trademark). The semiconductor memory may be either a nonvolatile memory or a volatile memory. Besides the semiconductor memory, a magnetic disk, a flexible disk, an optical disk, a compact disk, a mini disk, a digital versatile disc (DVD), or a different option may be used as the memory 12. The functions of each of the control devices 1A and 1B may be implemented partly with hardware and partly with software or firmware.

The voltage application unit 2 described herein includes the three-phase inverter circuit. However, the voltage application unit 2 may include an inverter with a different number of phases. The voltage application unit 2 to be used can be any of various voltage application units that include multi-level inverters, such as a three-level inverter and a five-level inverter.

While the stator currents iₛ for the torque of each of the rotating machines 3A and 3B are set to minimize the root-mean-square current value, the stator currents iₛ may be set to minimize the flux linkages or maximize efficiency of the voltage application unit 2 or each rotating machine 3A or 3B.

The above configurations illustrated in the embodiments are illustrative, can be combined with other techniques that are publicly known, and can be partly omitted or changed without departing from the gist.

### REFERENCE SIGNS LIST

1A, 1B control device; 2 voltage application unit; 3, 3A, 3B rotating machine; 4 current detector; 5 control unit; 6A, 6B position estimator; 7 stator; 8 rotor; 10 dedicated processing circuitry; 11 processor; 12 memory; 501 current command computation unit; 502 three-phase to two-phase transformation unit; 503 rotating frame transformation unit; 504 d-q current control unit; 505 inverse rotating frame transformation unit; 506 two-phase to three-phase transformation unit.

1. A control device for a rotating machine, the control device comprising:
a current detector to detect stator currents flowing through a stator of the rotating machine;
a position estimator to compute a rotor position estimate and a rotational speed estimate on a basis of computed flux linkages of the rotating machine, the rotor position estimate being an estimated position of a rotor of the rotating machine, the rotational speed estimate being an estimated speed;
a control circuitry to output stator voltage command values based on the stator currents and the rotor position estimate for driving the rotating machine; and
a voltage application circuitry to apply drive voltages to the rotating machine on a basis of the stator voltage command values, wherein
the position estimator updates the computed flux linkages on a basis of the stator voltage command values, the rotational speed estimate, and the computed flux linkages that are the most recent.

2. The control device for the rotating machine according to claim 1, wherein
the position estimator updates the computed flux linkages on a basis of the stator voltage command values, products of the rotational speed estimate and the computed flux linkages that are the most recent, and quotients of the stator voltage command values by the rotational speed estimate.

3. The control device for the rotating machine according to claim 1, wherein
the position estimator updates the computed flux linkages on a basis of the stator voltage command values, the products of the rotational speed estimate and the computed flux linkages that are the most recent, and differences between the computed flux linkages that are the most recent and the quotients of the stator voltage command values by the rotational speed estimate.

4. The control device for the rotating machine according to claim 1, wherein
the position estimator updates the computed flux linkages on a basis of first differences between the stator voltage command values and the products of the rotational speed estimate and the computed flux linkages that are the most recent and second differences between the computed flux linkages that are the most recent and the quotients of the stator voltage command values by the rotational speed estimate.

5. The control device for the rotating machine according to claim 1, wherein
inductance of the rotating machine includes a variable inductance component that varies with a rotor position, the rotor position being a rotational position of the rotor.

6. The control device for the rotating machine according to claim 5, wherein
the rotor of the rotating machine is permanent magnet-free.

7. The control device for the rotating machine according to claim 5, wherein
the rotor of the rotating machine includes a permanent magnet.

8. The control device for the rotating machine according to claim 5, wherein
the position estimator estimates the rotor position from flux-linkage inductance variation components that are included in flux linkages of the rotating machine and generated by the variable inductance component and the stator currents.

9. The control device for the rotating machine according to claim 8, wherein
the inductance of the rotating machine is divided into a mean component that does not vary with the rotor position and the variable inductance component that varies at twice an electrical angular frequency where the rotor position changes, and
the flux-linkage inductance variation components are magnetic fluxes generated by the stator currents and the variable component.
